(19) United States
(12) Patent Application Publication
(10) Pub. No.: US 2013/0061968 A1
(43) Pub. Date: Mar. 14, 2013

(54) SWITCHING DEVICE FOR CONDUCTING A FLUID

(71) Applicants: Bernhard Schlichter, Saarbrucken (DE); Manfred Deutschmeyer, Perl (DE)

(72) Inventors: Bernhard Schlichter, Saarbrucken (DE); Manfred Deutschmeyer, Perl (DE)

(21) Appl. No.: 13/261,506

(22) PCT Filed: May 21, 2011
(86) PCT No.: PCT/EP11/02541

§ 371 Date: Nov. 6, 2012

(30) Foreign Application Priority Data
Jun. 2, 2010 (DE) 10 2010 022 575.4

(51) Int. Cl. F16K 11/14

(52) U.S. Cl. 137/862; 137/625.13

(57) ABSTRACT

The invention relates to a switching device for conducting a fluid (2), comprising at least one distribution valve (7, 13) in a first fluid-conducting connection (5) between a first treatment apparatus (3) for the fluid (2) and a second treatment apparatus (4) for the fluid (2), at least one further distribution valve (8, 14) in a second fluid-conducting connection (6) between the first treatment apparatus (3) and the second treatment apparatus (4). The distribution valves (7, 8, 13, 14) each are associated with the first treatment apparatus (3) and/or the second treatment apparatus (4) and have a manually operable switching lever (11, 12, 15, 16) for switching the respective distribution valve (7, 8, 13, 14) at least between a blocking and opening of the respective fluid-conducting connection (5, 6) to the respective treatment apparatus (3, 4). Said switching device is characterized in that the switching levers (11, 12, 15, 16) of the distribution valves (7, 8, 13, 14) associated with the respective treatment apparatus (3, 4) are designed and arranged in such a way that the switching levers can be operated synchronously using one hand of an operating person.

The invention relates to a switching device for conducting a fluid, comprising at least one distribution valve in a first fluid-conducting connection between a first treatment apparatus for the fluid and a second treatment apparatus for the fluid and at least one other distribution valve in a second fluid-conducting connection between the first and the second treatment apparatus, with the distribution valves being assigned to the first and/or the second treatment apparatus respectively and having a manually actuated switching lever for switching the respective distribution valve at least between blocking and opening of the respective fluid-conducting connection to the respective treatment apparatus.

EP 1 731 809 A2 discloses a switching device for two multi-treatment devices in the manner of filter devices for filtering a fluid flow. The multi-treatment devices of the generic type are, for example, two filter devices which can be connected to one another to carry fluid via one inlet connecting line and one outlet connecting line. In each connecting line, there is one inlet-side distribution valve or one outlet-side distribution valve for each treatment apparatus. In each distribution valve, there is a valve element or valve body which can be moved back and forth between two switching positions, where in the switching positions one of the treatment apparatus at a time is exposed to the fluid flow and the other treatment apparatus is shut off from the pertinent fluid flow. The valve bodies of the respectively inlet-side and outlet-side distribution valve are interconnected in a torsionally strong manner via a switching shaft. In this way, a desired simultaneous actuation of the distribution valves is enabled. For the filtering of toxic or environmentally harmful gases, there is moreover a so-called bleed port with a venting and intermediate exhaust device as the safety apparatus between two sealed sites on each valve element of the distribution valves.

DE 600 05 552 T2 describes a switching device in a construction similar to the above-described switching device, where, in addition to the distribution valves, there is one safety valve at a time in the connecting lines in order to achieve reliable sealing via the safety valve when a seal seat of a distribution valve fails. The distribution valves and the two safety valves in the inlet connecting line and the outlet connecting line are connected to a switching shaft and can be actuated positively coupled. The switching levers of the switching shaft are positively coupled in turn via crank guides such that the three switching shafts can be actuated in succession only in a mechanically fixed sequence. On each safety valve, there are two venting valves assigned to a common venting port.

The switching devices according to the prior art are not optimized with respect to their installation cost, since in particular the use of switching shafts does not allow an identically constructed valve housing and identically constructed valve elements, so that this results in additional installation and component costs.

Based on prior art, the object of the present invention is to devise a switching device which is economical, whose installation cost is low, and which is reliable in use.

This object is achieved with a switching device having the features specified in claim 1 in its entirety. A switching device according to the invention is characterized in that the switching levers of the distribution valves assigned to the respective treatment apparatus are made and arranged such that they can be synchronously actuated by an operator with one hand. Advantageous embodiments of the switching device according to the invention are subject matters of the dependent claims.

Since a coupling of the valve elements of the distribution valves which are located in the first and second fluid-conducting connection and whose function can be coupled to the operation of the treatment apparatus is accomplished such that they are not interconnected via a switching shaft or in some other driven manner, it becomes possible to make the distribution valves identically in pairs at least with respect to their valve housing and the valve elements. The valve elements are each connected to a switching lever, with the switching levers being arranged in space to one another such that the switching levers can be actuated at least in pairs by one hand and thus the distribution valves can also be synchronously actuated. The distribution valves can thus be operated properly and reliably by one operator without the need for mechanical coupling of their valve elements, for example, by switching shafts.

By dispensing with mechanical coupling means, the distribution valves can also be made almost identical or completely identical; this helps reduce the production costs of the switching device. No shaft glands on the valve housings and similar complex gear couplings for the individual distribution valves are necessary. It is still possible to choose the shape of the switching levers to be identical, for example, by their longitudinal axes and outside surfaces running offset to one another. In this way, for example, two switching levers at a time can be attached in mirror image to one another to the distribution valves of the switching device which are arranged flush over a common longitudinal axis. In a surprisingly simple and advantageous manner, this ensures a position of the free ends of the switching levers that are guided to one another. The ends of the switching levers can be easily and very precisely guided jointly into the desired switching position with one hand, but can also be triggered individually by hand as required.

To operate the treatment apparatus, it is generally necessary for the valve elements of the distribution valves which are coupled in pairs in their operation to have the same position relative to their switching levers. The valve elements are therefore preferably provided with the same passage openings, for example T-shaped or L-shaped, or with straight passage openings. In order to ensure especially reliable switchover during operation from the first to the second treatment apparatus and vice versa, it is advantageous to provide between the two distribution valves in the first fluid-conducting connection and the second fluid-conducting connection one safety valve at a time which moreover preferably enables the discharge and supply of fluid into one of the two treatment apparatus at a time. This fifth and sixth valve can have a valve element with an L-shaped passage opening and can likewise be operated with two switching levers which can be actuated with one hand.

The safety valves are preferably, however, coupled to a mechanical coupling, especially in the manner of a switching shaft. These valves can moreover be provided with a needle valve for pressure equalization of a first and a second fluid-conducting connection between the first and second treatment apparatus. In this way, a treatment apparatus which has been shut down can be reliably transferred into an unpressurized state. The treatment apparatus can then be opened accordingly, for example, for replacement of filters or for other measures, such as, for example, for replacement of worn process control elements or devices.

A switching device for switching a fluid flow between two treatment apparatus and their operation are detailed below based on an exemplary embodiment.

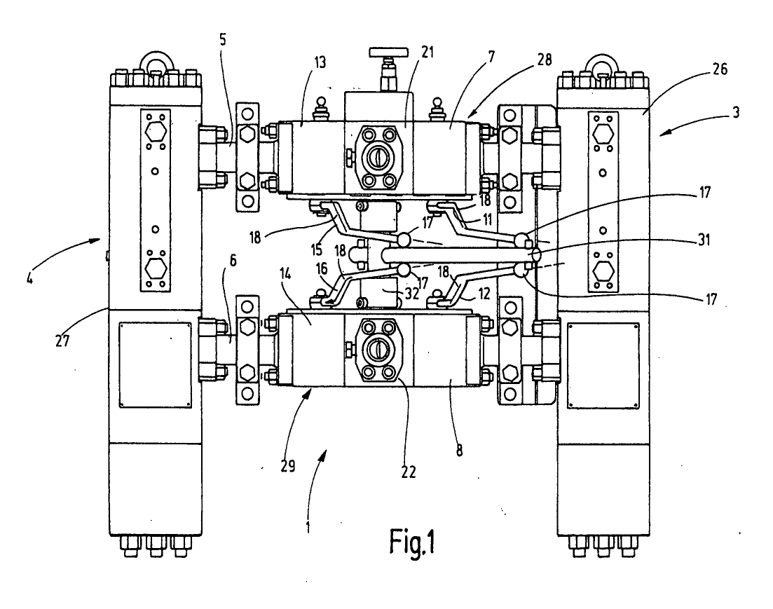

FIG. 1 shows an exemplary embodiment of a switching device for a fluid flow, especially for routing a highly pressurized fluid in two treatment apparatus;

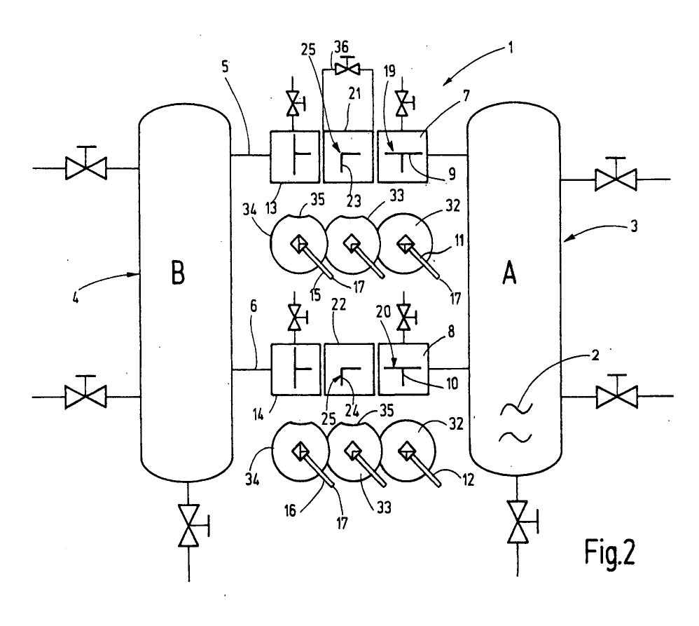

FIGS. 2 to 8 each show a schematic side view of the treatment apparatus with a schematic plan view of the switching device according to FIG. 1 in different operating phases in the respective switchover of the fluid flow from one treatment apparatus to the other treatment apparatus, which view is shown in the center.

FIG. 1 shows an exemplary embodiment of a switching device 1 for conducting a fluid 2, which constitutes a liquid process flow which is to be filtered, into alternatively a first or a second treatment apparatus 3 (=A) and 4 (=B). The treatment apparatus 3, 4 in the illustrated exemplary embodiment are each made with a filter housing which contains the corresponding filter elements. The switching device 1 is used in particular to control the inflow of fluid 2 via a valve 22 alternatively into the first treatment apparatus 3 or into the second treatment apparatus 4.

The treatment apparatus 3, 4 can be interconnected to conduct fluid via a first fluid-conducting connection 5 and a second fluid-conducting connection 6 or can be separated again from one another. The fluid-conducting connections 5, 6 are arranged as pressure-proof pipelines with screw flanges between the respective pressure-proof housings 26, 27 of the first treatment apparatus 3 and the second treatment apparatus 4. The first fluid-conducting connection 5 is used to discharge filtered fluid 2 while the second fluid-conducting connection 6 is designed for supplying unfiltered fluid into one or the other treatment apparatus 5, 6.

The filtered fluid is discharged via a valve 21 which is mounted in the center in the first fluid-conducting connection 5. Likewise, the valve 22 is located roughly in the center in the second fluid-conducting connection 5. Overall, the two valves 21, 22 are located in one valve block 28, 29 each, with two other laterally bordering valves. In the first fluid-conducting connection 5, that is to say, on both sides of the valve 21, there are a first distribution valve 7 and a third distribution valve 13 in the valve block 28. In the second fluid-conducting connection 6, on both sides of the valve 22, there are a second and a fourth distribution valve 8, 14 in the valve block 29. The distribution valves 7, 13 and 8, 14 are provided with valve elements 9, 10 which are made as ball segments and whose passage openings 19, 20 are each made T-shaped (cf. FIGS. 2 to 8).

The first and the second distribution valve 7, 8 are adjacent to the first treatment apparatus 3 and are assigned to it in the sense that they can open or block the respective fluid-conducting connections 5, 6 to the first treatment apparatus 3. The third and fourth distribution valve 13, 14 are assigned to the second treatment apparatus 4 in the same manner of operation. In the blocked state of the pertinent distribution valves 7, 8, 13, 14, the treatment devices 3, 4 can be emptied or can be used for process steps other than fluid passage, such as, for example, maintenance work, for replacement of process control elements such as filters and the like.

In addition to supplying or discharging fluid or detergents or similar process substances, the valves 21, 22 designated as the fifth and sixth valve below, using integrated needle valves 36 are designed to equalize pressure in preparation for switching over from one treatment apparatus to the other in the fluid-conducting connections 5, 6. The valve elements 23, 24 of these fifth and sixth valves 21, 22 have L-shaped passage openings 25 which can otherwise control a switchover of the supply or discharge fluid flow from the first treatment apparatus 3 and the second treatment apparatus 4 accordingly.

As FIG. 1 in particular furthermore shows, the first and second as well as the third and fourth distribution valves 7, 8, 13, 14 are provided with manually actuated switching levers 11, 12, 15, 16. The switching levers 11 and 15 of the first and third distribution valves 7, 13 are screwed on the respective valve element suspended whereas the switching levers 12, 16, pointed inversely to the switching levers 11, 5, are screwed from overhead onto the pertinent valve elements of the distribution valves 8, 14. Each longitudinal axis 18 of an assigned switching lever, proceeding from the valve element, viewed toward its respective free end 17, is made offset. In this way, the free ends 17 are brought close together in space, but without touching one another. Thus, the respectively free ends 17 of the first and second switching lever 11, 12 and the free ends 17 of the third and fourth switching lever 14, 16 can be jointly grasped with one hand, and the switching levers can be synchronously guided from one switching position to the other. Preferably, no detents should need to be overcome.

The fifth and sixth valve 21, 22 or their valve elements 23, 24 are conventionally positively coupled via a shaft 30 and can be turned only jointly. For this purpose, the shaft 30 has another manually actuated switching lever 31 which, depicted, is projecting in the same direction as the other switching levers so that the entire switching device 1 can be operated from a single operator side by one operator.

As the schematic plan views according to FIGS. 2 to 8 show, the possible switchover process from one treatment apparatus 3 to the other treatment apparatus 4 via the actuation of the respective switching lever is positively coupled using disk cams 32, 33, 34. The disk cams 32, 33, 34 are permanently connected to the respective assignable switching levers or valve elements, and each has a circular segment-shaped cutout 35 on their peripheral edge. The cutout 35 of each disk cam can interact with one peripheral edge of the respectively adjacent disk cam such that a rotary motion is enabled or just blocked.

FIG. 2 shows an operating position of the switching device 1 in which fluid 2 flows against the first treatment apparatus 3 via the sixth valve 22 and the second distribution valve 8. Via the first distribution valve 7 and the fifth distribution valve 21 the fluid 2 leaves the first treatment apparatus 3. The disk cams 32, 33 of these valves are blocked by the disk cams 32 with their sections 35 making contact with the peripheral edge of the disk cams 33. The second treatment apparatus 4 is unpressurized and can be serviced, for example, in the pertinent operating phase. Thus, in this operating phase, a replacement of filter elements (old element by new element), which are not detailed, can take place. In both treatment apparatus 3, 4 otherwise there are the same process steps, specifically a filtering for the fluid 2 which is flowing through the filter elements.

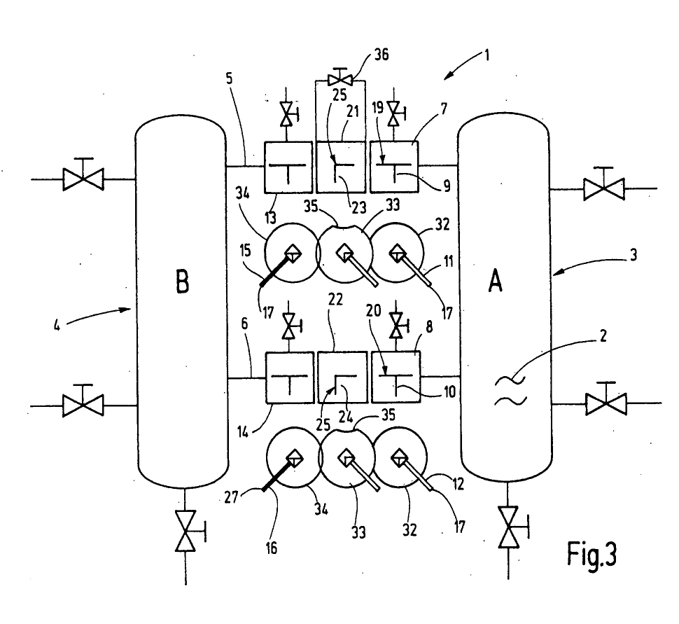

FIGS. 3 to 8 show the switchover process on the switching device 1 from the operation of the first treatment apparatus 3 to the second treatment apparatus 4. In FIG. 3, first an unblocking of the third and fourth distribution valves 13, 14 is shown. Their switching levers 15, 16 are pivoted to the left in the direction of looking at FIG. 3. The other valves remain in their illustrated switching positions.

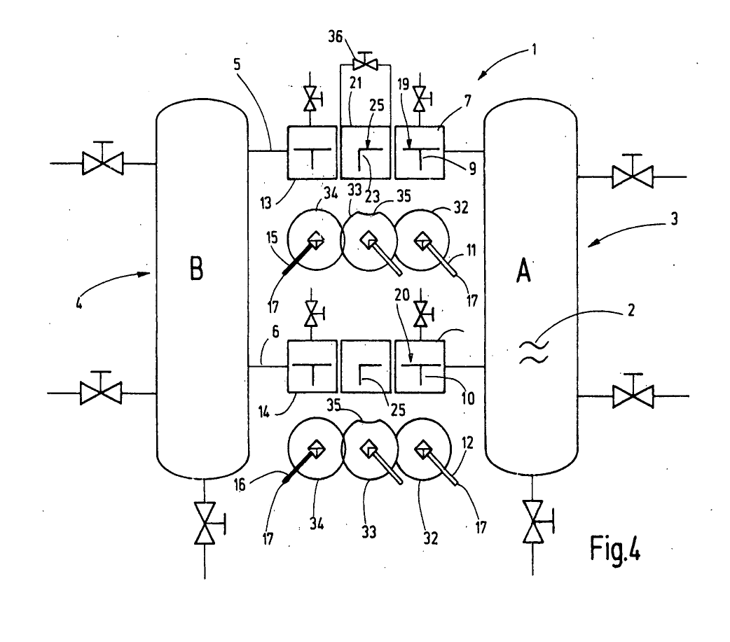

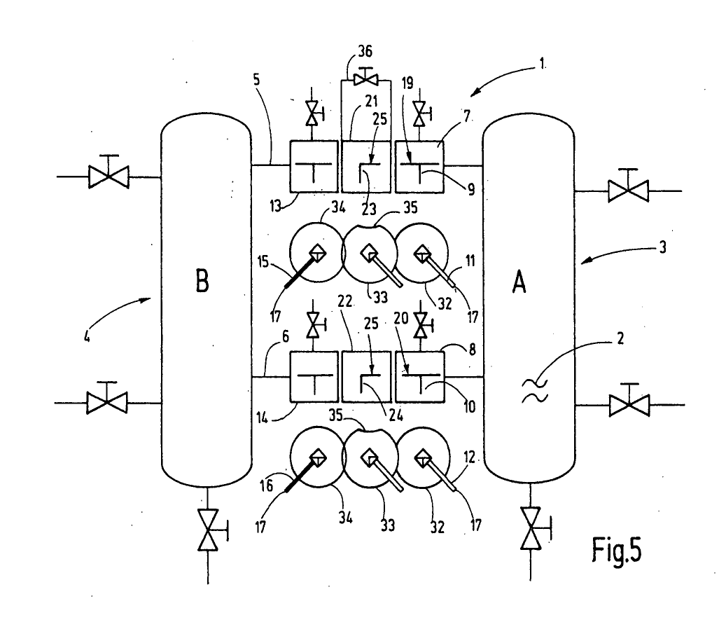

FIG. 4 shows a subsequent pressure equalization between the first treatment apparatus 3 via the needle valve 36 which bridges the first valve 21. FIG. 5 in turn illustrates the completed pressure equalization process.

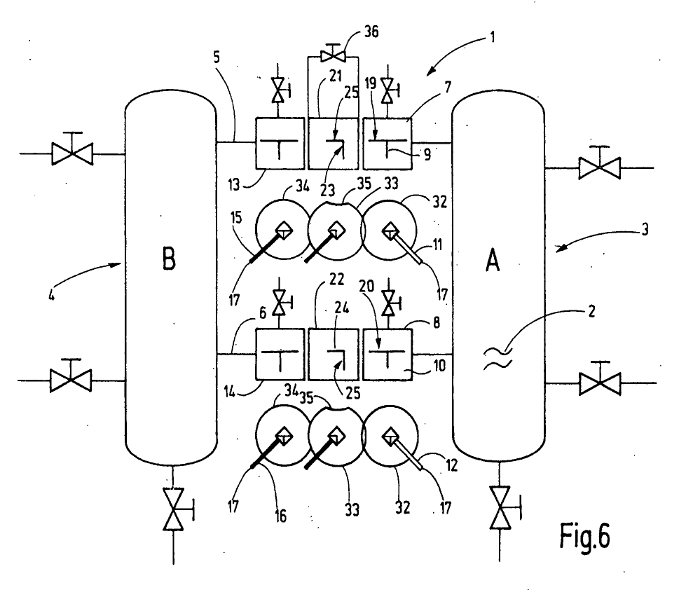

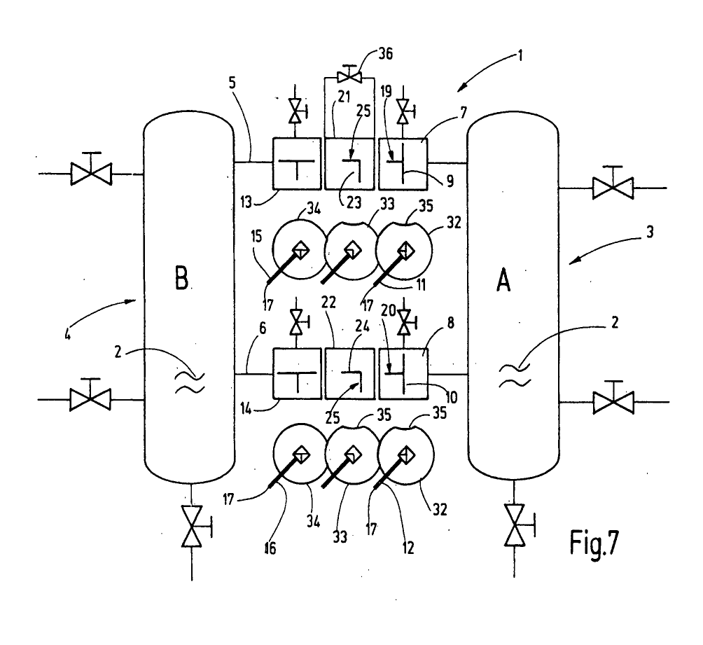

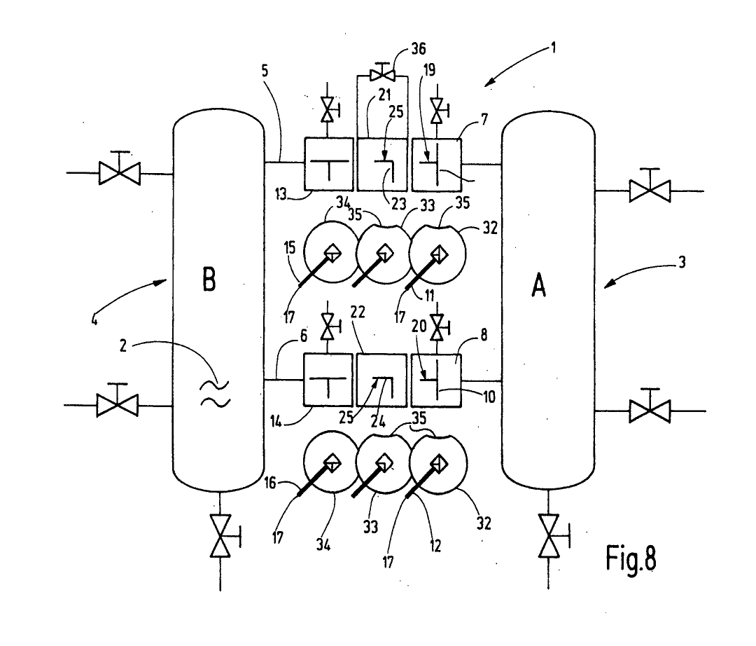

FIG. 6 shows the switchover from the operation of the first treatment apparatus 3 to the second treatment apparatus 4. For this reason, the switching lever 31 on the shaft 30 is pivoted from right to left. In this way, the fifth and sixth valve 21, 22 route the fluid flow to the second treatment apparatus 4. FIGS. 7 and 8 show the lowering of the pressure in the first treatment apparatus 3, the graphic symbols shown on the valve elements obviously representing the respective switching process for the viewer.

1. A switching device for conducting a fluid (2), comprising the following:
at least one distribution valve (7, 13) in a first fluid-conducting connection (5) between a first treatment apparatus (3) for the fluid (2) and a second treatment apparatus (4) for the fluid (2),
at least one other distribution valve (8, 14) in a second fluid-conducting connection (6) between the first (3) and the second treatment apparatus (4),
with the distribution valves (7, 8, 13, 14) being assigned to the first (3) and/or the second treatment apparatus (4) respectively and having a manually actuated switching lever (11, 12, 15, 16) for switching the respective distribution valve (7, 8, 13, 14) at least between blocking and opening of the respective fluid-conducting connection (5, 6) to the respective treatment apparatus (3, 4),
characterized in that the switching levers (11, 12, 15, 16) of the distribution valves (7, 8, 13, 14) assigned to the respective treatment apparatus (3, 4) are made and arranged such that they can be synchronously actuated by an operator with one hand.

2. The switching device according to claim 1, characterized in that there are two distribution valves (7, 8, 13, 14) each in the fluid-conducting connections (5, 6), that a first distribution valve (7) in the first fluid-conducting connection (5) and a second distribution valve (8) in the second fluid-conducting connection (6) are assigned to the first treatment apparatus (3) and their switching levers (11, 12) can be synchronously actuated in pairs, and that a third distribution valve (13) in the first fluid-conducting connection (5) and a fourth distribution valve (14) in the second fluid-conducting connection (6) are assigned to the second treatment apparatus (4) and their switching levers (15, 16) can be synchronously actuated in pairs.

3. The switching device according to claim 1, characterized in that the switching levers (11, 12, 15, 16) have the same shape.

4. The switching device according to claim 1, characterized in that the switching levers (11, 12, 15, 16) each run offset facing one another with their free ends (17) relative to their longitudinal axes (18).

5. The switching device according to claim 1, characterized in that the distribution valves (7, 8, 13, 14) which can be jointly actuated in the first and second fluid-conducting connection (5, 6) have the same passage openings (19, 20) on their valve element (9, 10).

6. The switching device according to claim 1, characterized in that the passage openings (19, 20) of the valve elements (9, 10) of the distribution valves (7, 8, 13, 14) have a T-shaped construction.

7. The switching device according to claim 1, characterized in that there is one valve (21) in the first fluid-conducting connection (5) for supplying and/or discharging fluid (2).

8. The switching device according to claim 2, characterized in that the valve (21) is located between the first (7) and the third distribution valve (13).

9. The switching device according to claim 1, characterized in that there is another valve (22) in the second fluid-conducting connection (6) for supplying and/or discharging fluid (2).

10. The switching device according to claim 2, characterized in that the other valve (22) is located between the second (8) and the fourth distribution valve (14).

11. The switching device according to claim 7, characterized in that the valves (21, 22) are positively coupled and can be manually actuated via a common switching lever (31).

12. The switching device according to claim 7, characterized in that the passage openings (25) of a valve element (23) of the valve (21) and/or another valve element (24) of the other valve (22) run in an L-shape.
